(19) United States
(12) Patent Application Publication
(10) Pub. No.: US 2007/0156400 A1
(43) Pub. Date: Jul. 5, 2007

(54) System and method for wireless dictation and transcription

(76) Inventor: Mark R. Wheeler, Lansing, NY (US)

Correspondence Address: PASTEL LAW FIRM;CHRISTOPHER R. PASTEL, 8 PERRY LANE, ITHACA, NY, 14850-9267, US

(21) Appl. No.: 11/324,577

(22) Filed: Jan. 3, 2006

(51) Int. Cl. G10L 15/26

(52) U.S. Cl. 704/235

(57) ABSTRACT

A system and method for wireless dictation and transcription includes an input device which is connected by the Internet to a computer. The user dictates into the input device which is stored as an audio file which is then sent to the computer for voice recognition training and/or batch transcription. After the audio file has been transcribed into a processed document, the document is available to the user either through the Internet or by e-mail.

### FIELD OF THE INVENTION

This invention relates generally to the field of speech recognition and transcription, and more particularly to a system and method for wireless dictation and transcription, with the work product available through the Internet.

### BACKGROUND OF THE INVENTION

Voice recognition software is known, with the two most well known programs being Dragon NaturallySpeaking® by Nuance Communications, Inc. and ViaVoice® by International Business Machines. Both programs permit a user to speak into a microphone so that the software performs voice recognition on the speech to convert the speech to text in a real-time interactive mode. The programs are resident on a computer, with the resulting text displayed on the screen of the computer.

The microphone used can be a typical microphone connected by a wire to the computer or can be a PDA (personal digital assistant) which in turn is connected to the computer via a cradle. User intervention is required at the computer to process and display the resulting text.

### SUMMARY OF THE INVENTION

Briefly stated, a system and method for wireless dictation and transcription includes an input device which is connected by the Internet to a computer. The user dictates into the input device which is stored as an audio file which is then sent to the computer for voice recognition training and/or batch transcription. After the audio file has been transcribed into a processed document, the document is available to the user either through the Internet or by e-mail.

According to an embodiment of the invention, a system for dictation and transcription includes means for receiving an audio file from a user via a first Internet connection; batch transcription means for batch computer transcription of the audio file into a processed document; and means for making the processed document available to the user via a second Internet connection and/or e-mail.

According to an embodiment of the invention, a method for dictation and transcription includes the steps of (a) receiving an audio file from a user via a first Internet connection; (b) transcribing, using a computer in batch mode, the audio file into a processed document; and (c) making the processed document available to the user via a second Internet connection and/or e-mail.

### BRIEF DESCRIPTION OF THE DRAWINGS

FIG. 1 shows a flow chart depicting the initial sequence of an embodiment of the present invention.

FIG. 2 shows a flow chart depicting the client software login logic according to an embodiment of the present invention.

FIG. 3 shows a flow chart depicting the client software user status determination logic according to an embodiment of the present invention.

FIG. 4 shows a flow chart depicting the client software user training logic according to an embodiment of the present invention.

FIG. 5 shows a flow chart depicting the sequence of using a voice recorder to create a dictation according to an embodiment of the present invention.

FIG. 6 shows a flow chart depicting the user application menu workflow according to an embodiment of the present invention.

FIG. 7 shows a flow chart depicting the application server logic according to an embodiment of the present invention.

FIG. 8 shows a flow chart depicting the server transcription logic according to an embodiment of the present invention.

FIG. 9 shows a flow chart depicting the server training logic according to an embodiment of the present invention.

FIG. 10 shows a flow chart depicting the web site logon logic according to an embodiment of the present invention.

FIG. 11 shows a flow chart depicting the speaker ID logon menu logic according to an embodiment of the present invention.

FIG. 12 shows a flow chart depicting the review of transcriptions logic according to an embodiment of the present invention.

FIG. 13 shows a flow chart depicting the continual training logic according to an embodiment of the present invention.

FIG. 14 shows a flow chart depicting the account manager menu logic according to an embodiment of the present invention.

FIG. 15 shows a schematic depicting the application service server network topology according to an embodiment of the present invention.

### DETAILED DESCRIPTION OF THE PREFERRED EMBODIMENT

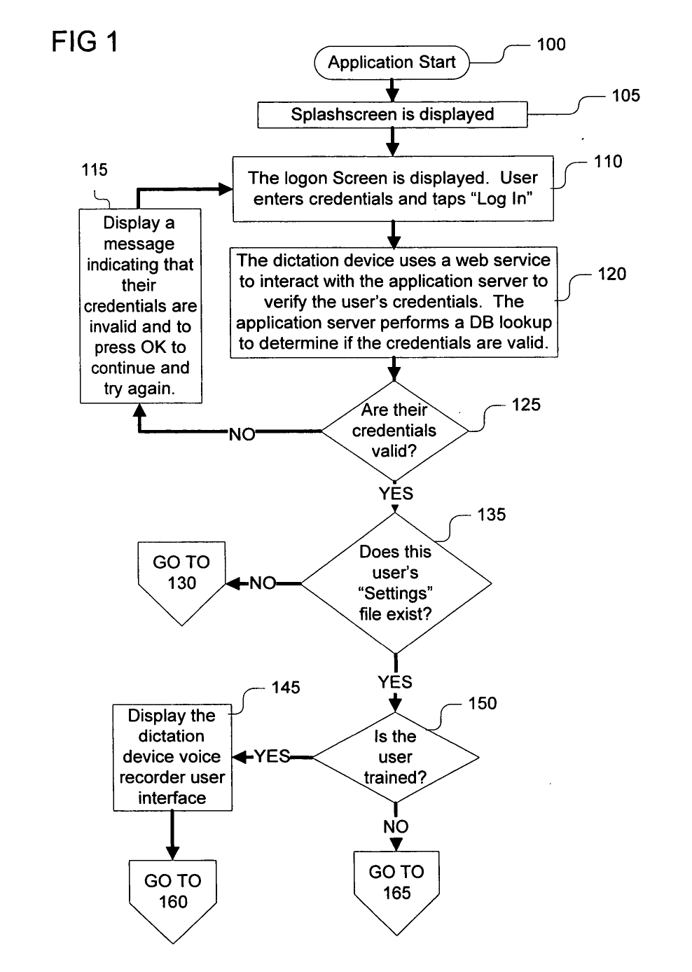

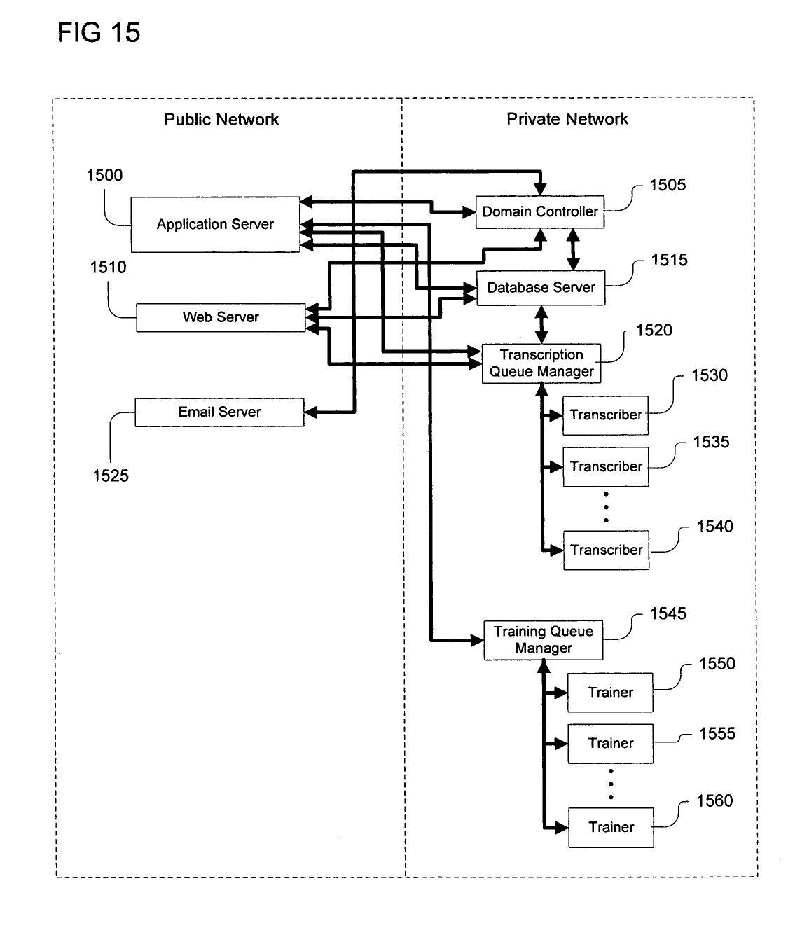

Referring to FIG. 1, the method of the present invention begins at step 100. The splashscreen is displayed in step 105, after which the logon screen is displayed in step 110. The user enters the proper credentials which are validated in step 120. A dictation device such as a PDA, Tablet, desktop PC, cell phone (pocket-PC or windows based), cell phone PDA, or laptop PC, preferably uses a web service to interact with an application server 1500 (FIG. 15) to verify the user's credentials. Application server 1500 preferably performs a DB lookup to determine if the credentials are valid. If the credentials are not valid as determined in step 125, an appropriate message is displayed in step 115 and the logon screen is again displayed in step 110. If the credentials are valid as determined in step 125, the program checks in step 135 to see if the user's “settings” file exists. The “settings” file preferably stores the dictation device ID and the local preferences for this user. Each user has a unique settings file.

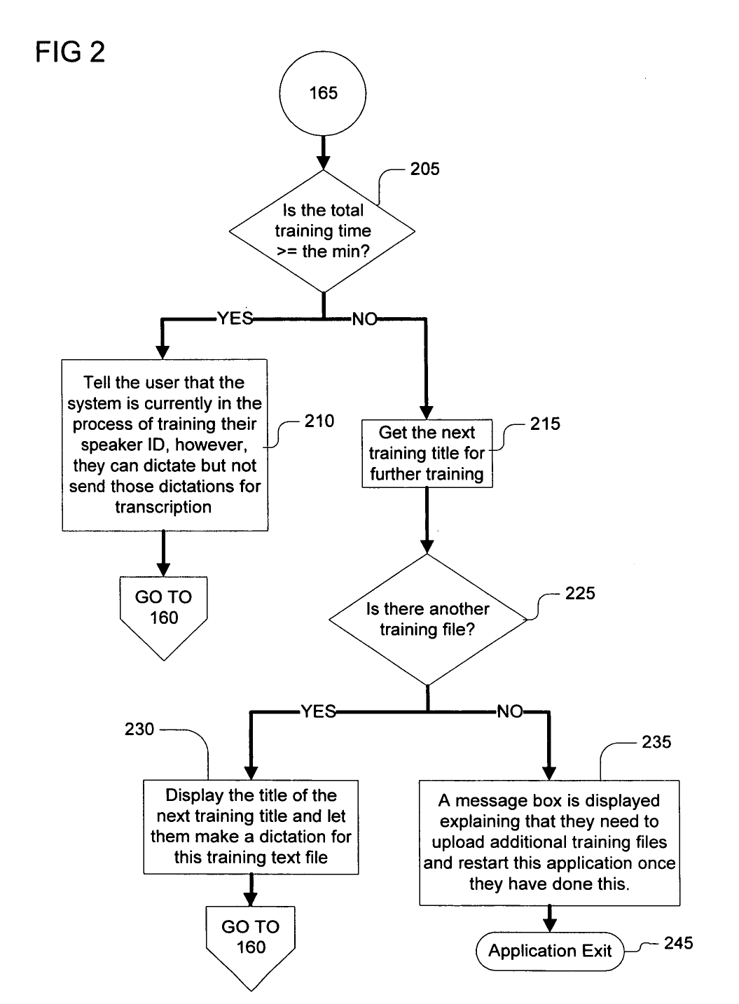

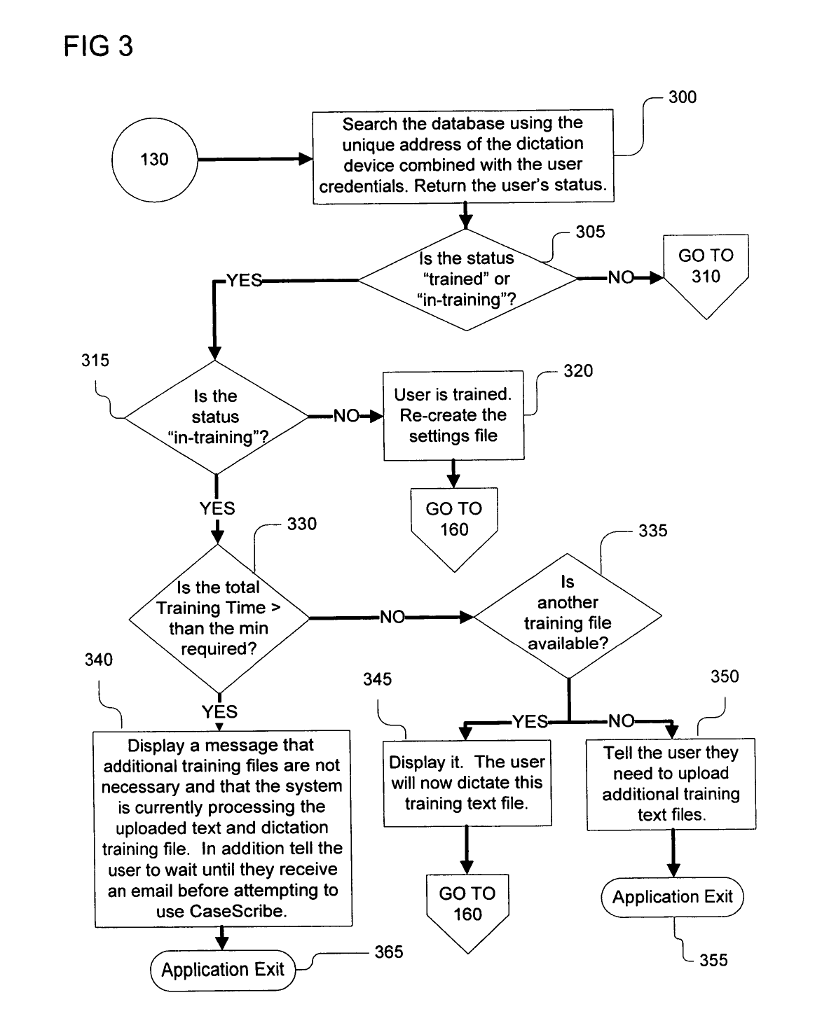

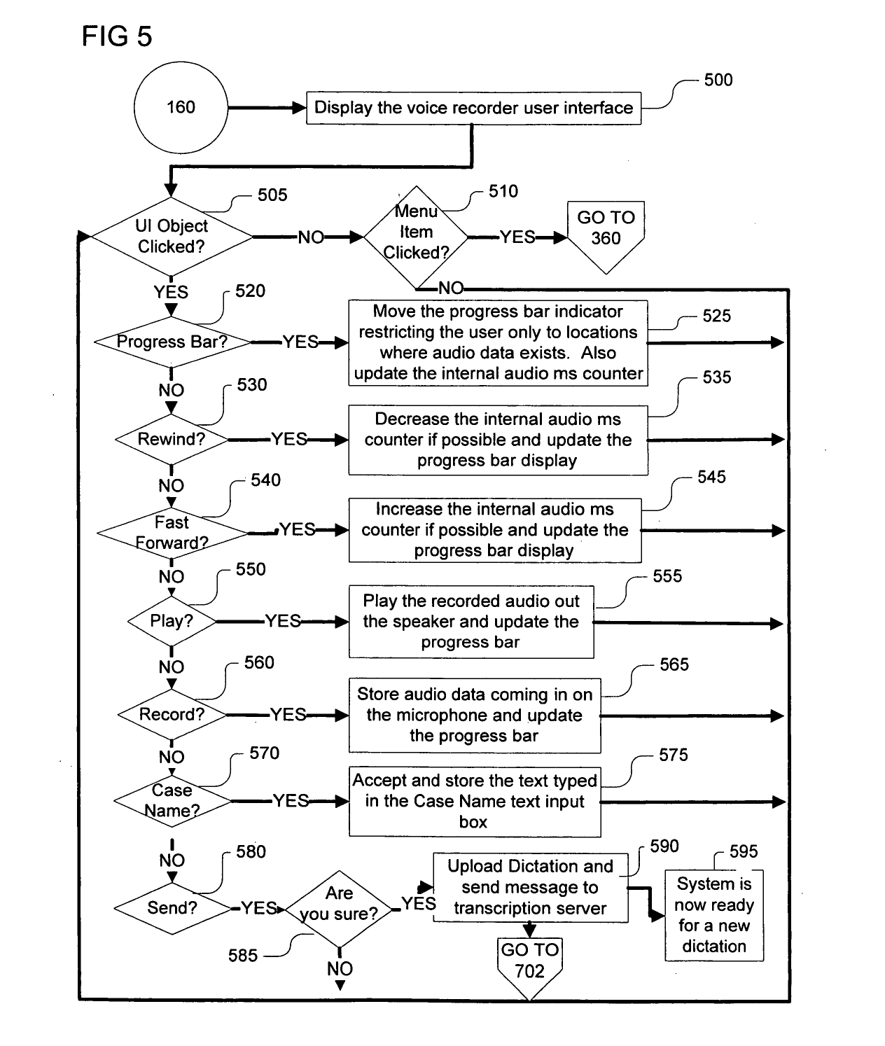

If the user's “settings” file does not exist, program control goes to step 130 (FIG. 3). If the user's “settings” file exists, the system checks to see if the user is trained in step 150. If the user is not trained, which means that the user needs to be trained, is just beginning to start training, or has started training but not yet competed it, then program control goes to step 165 (FIG. 2), Otherwise, the dictation device voice recorder user interface is displayed in step 145, after which program control passes to step 160 (FIG. 5).

Referring to FIG. 2, in the case of an untrained user, the system checks in step 205 to see if the total training time is greater than or equal to the minimum training time. The minimum training time depends on the particular voice recognition software's training requirements. Dragon NaturallySpeaking® Server Edition (Nuance Communications, Inc.) is the preferred voice recognition software used in conjunction with the system and method of the present invention. A training file is preferably used by the voice recognition software to create a voice profile. If the user has not reached the minimum training time, the next training title is obtained in step 215 for further training. Then the system checks in step 225 to see if there is another training file. If not, a message is displayed in step 235 explaining that the user needs to upload additional training files and restart the present application once the additional training files are uploaded. The application then exits at step 245. If there is another training file, the title of the next training file is displayed in step 230 and the user is permitted to make a dictation for this next training file. Program control then goes to step 160 in FIG. 5. If the user has reached the minimum training time (step 205), the user is told that the system is currently in the process of training the user's speaker ID, and that the user can dictate but not send the dictations into the system for transcription. System control then passes to step 160 in FIG. 5.

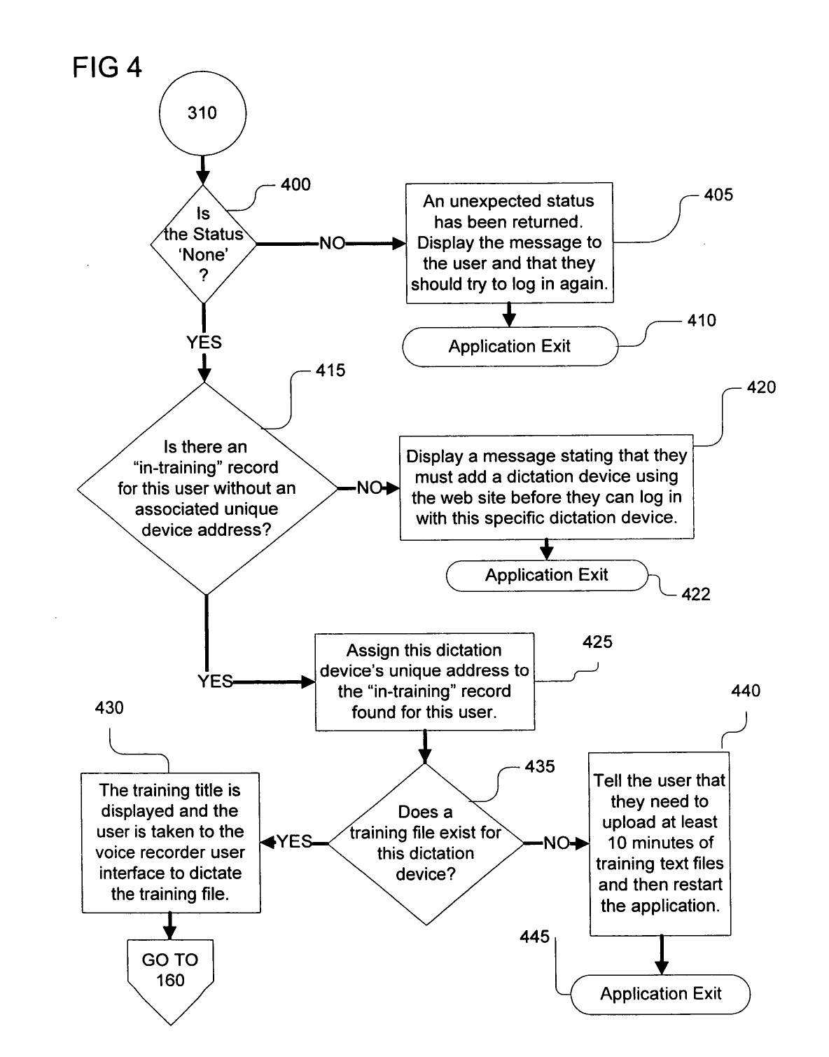

Referring to FIG. 3, if the user's “settings” file does not exist in step 135, the database is searched in step 300 using the unique address of the dictation device combined with the user's credentials. The user's status is returned and then checked in step 305 to see if the status is “trained” or “in-training.” If the user's status is neither of these, program control goes to step 310 in FIG. 4. The system checks to see if the user's status is “in-training” in step 315, and if not, the user is trained in step 320 and the “settings” file is re-created, after which system control goes to step 160 in FIG. 5. If the user's status is “in-training”, the system checks in step 330 to see if the total training time of the user is greater than the minimum training time required. If not, the system checks in step 335 to see if there is another training file. If there is not another training file available, a message is displayed in step 350 explaining that the user needs to upload additional training files and restart the present application once the additional training files are uploaded. The application then exits at step 355. If there is another training file, the next training file is displayed in step 345 and the dictates this next training file. Program control then goes to step 160 in FIG. 5. If the user has reached the minimum training time (step 330), a message is displayed in step 340 stating that additional training files are not necessary and that the system is currently processing the uploaded text and dictation training file. The user is also preferably told to wait for e-mail notification before attempting to use the system again, after which the application exits at step 365.

Referring to FIG. 4, if the status is neither “trained” nor “in-training” from step 305, the system checks in step 400 to see if the status is “none.” If not, an unexpected status has been returned, so a message is preferably displayed to the user in step 405 that the user should try to log in again, after which the application exits in step 410. If the status is none in step 400, the system checks in step 415 to see if there is an “in-training” record for this user without an associated unique device address. If not, a message is preferably displayed to the user in step 420 stating that the user must add a dictation device using the web site on web server 1510 (FIG. 15) before they can log in with this specific dictation device. The application then exits in step 422. If there is an “in-training” record for this user without an associated unique device address (step 415), this dictation device's unique address is assigned in step 425 to the “in-training” record found for this user. The system then checks in step 435 to see if a training file exists for this dictation device, and if not, a message is preferably displayed to the user in step 440 stating that the user needs to upload at least a specified number of minutes of training text files and then restart the application. The application then exits in step 445. If no training file exists for this dictation device, the training title is preferably displayed in step 430 and the user is taken to the voice recorder user interface at step 160 to dictate the training file.

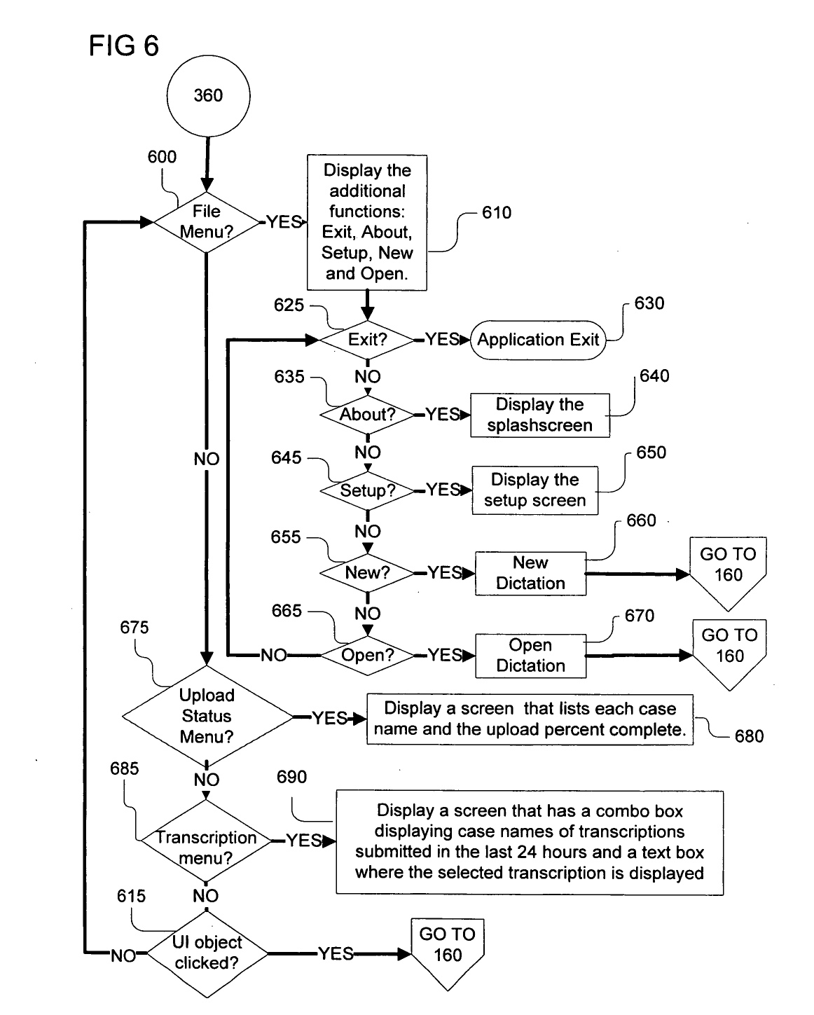

Referring to FIG. 5, the steps relating to using the voice recorder to create a dictation are shown. Dictation files are created in batches in their entirety on the user's dictation device and are modified by the user as necessary. The dictation file is then sent by the user by pressing the Send button at which time the system transfers the dictation file stored on the dictation device in a background process allowing the user to record other dictations. This process is known as batch transcription. The voice recorder user interface is preferably displayed to the user in step 500. This interface preferably includes objects such as buttons or icons for the following actions: File Menu, and the user interface objects for Progress Bar, Rewind, Fast Forward, Play, Record, Case Name, and Send. The system begins by checking to see if a user interface (UI) Object is clicked in step 505, and if not, the system checks in step 510 to see if a Menu Item is clicked. If yes, system control passes to step 360 in FIG. 6, while if not, the system goes to step 505 again to wait for input. Once the UI Object is clicked in step 505, the system checks in step 520 to see if the Progress Bar is clicked. If so, a progress bar indicator is moved in step 525, but the system preferably restricts the user only to locations in the progress bar where audio data exists, after which system control returns to step 505. If the user moves the progress bar indicator, this indicates that the user wants to change the position where the system is also looking, presumably to either start playback at that point or record over what was there. If the user attempts to move this progress bar indicator beyond the current recording, the system preferably does not allow that change to occur. Generally, the system will not allow the user to move the progress bar indicator beyond the end of the current recording. If the Progress Bar is not clicked, the system checks in step 530 to see if the Rewind Object is clicked, and if so, the internal audio ms counter is decreased if possible and the progress bar display is updated in step 535, after which system control returns to step 505.

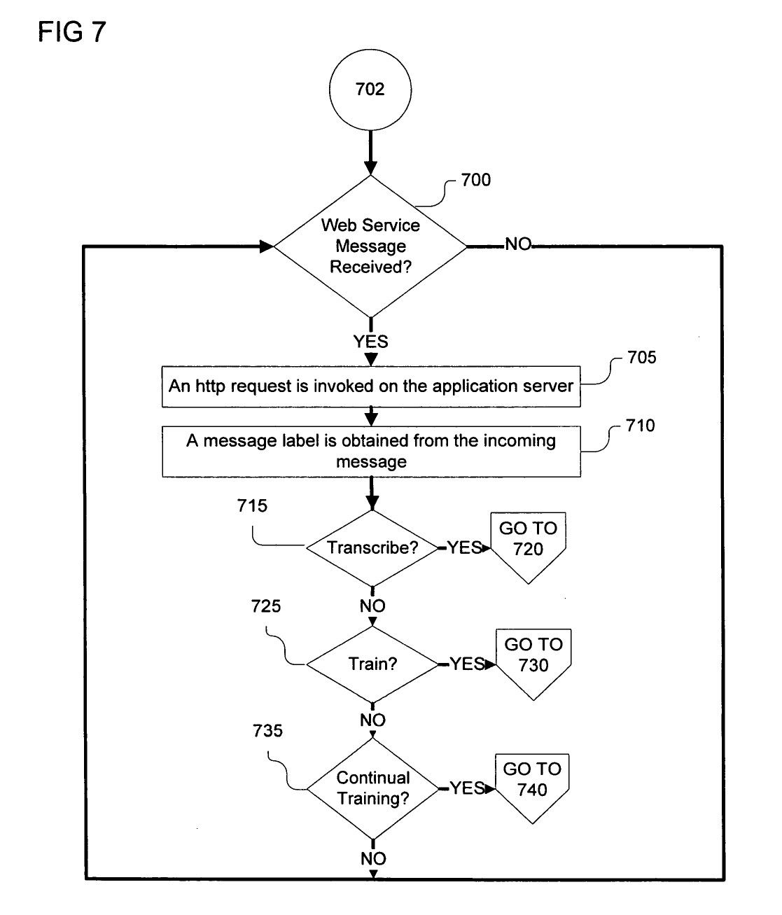

If the Rewind Object is not clicked, the system checks in step 540 to see if the Fast Forward object is clicked, and if so, the internal audio ms counter is increased if possible and the progress bar indicator display is updated in step 545, after which system control returns to step 505. If the Fast Forward object is not clicked, the system checks in step 550 to see if the Play object is clicked, and if so, the recorded audio is played out the speaker and the progress bar indicator display updated in step 555, after which system control returns to step 505. If the Play object is not clicked, the system checks in step 560 to see if the Record object is clicked, and if so, the audio data coming in from the microphone is recorded and the progress bar indicator display updated in step 565, after which system control returns to step 505. If the Record object is not clicked, the system checks in step 570 to see if the Case Name object is clicked, and if so, the text typed in the Case Name text input box is accepted and stored in step 575, after which system control returns to step 505. If the Case Name object is not clicked, the system checks in step 580 to see if the Send object is clicked, and if so, a message is preferably sent to the user in step 585 asking, “Are you sure?”, and if the user responds “no”, system control returns to step 505. If the user responds “yes”, the dictation is uploaded in step 590 while a message sent to the transcription server (see step 702 in FIG. 7) to transcribe the uploaded dictation as long as the dictation is not a training file. If the dictation is a training file, no message is sent to the transcription server until all training dictations have been received, at which time a message is sent to step 702 (FIG. 7) to initiate the training process for this speaker ID. In step 595 the system is now ready for a new dictation.

Referring to FIG. 6, the file menu functions are explained. If the user clicks on the File Menu object in step 510 (FIG. 5), system control passes to step 360. The system checks in step 600 to see if the File Menu was clicked, and if not, the system checks in step 675 to see if the Upload Status Menu was clicked. If so, a screen is displayed in step 680 that preferably displays each case name and the upload complete percentage. If not, the system checks to see if the Transcription Menu is clicked, and if so, a screen is displayed in step 690 that preferably has a combo box displaying case names of transcriptions submitted in the last twenty-four hours and a text box where the selected transcription is displayed. If not, the system checks in step 615 to see if a UI Object is checked, and if so, system control goes to step 160 (FIG. 5), and if not, system control loops back to step 600.

If the File Menu is recognized in step 600 as being clicked, the additional functions are preferably displayed in step 610: Exit, About, Setup, New, and Open. In step 625, the system checks to see if Exit is clicked, and if so, the application exits in step 630. Otherwise, the system checks in step 635 to see if About is clicked, and if so, the splashscreen is displayed in step 640. If not, the system checks in step 645 to see if Setup is clicked, and if so, the setup screen is displayed in step 650. Otherwise, the system checks in step 655 to see if New is clicked, and if so, new dictation begins in step 660 and system control goes to step 160 (FIG. 5). If not, the system checks in step 665 to see if Open is clicked, and if so, open dictation begins in step 670 and system control goes to step 160 (FIG. 5). Otherwise, system control loops back to step 625 awaiting input.

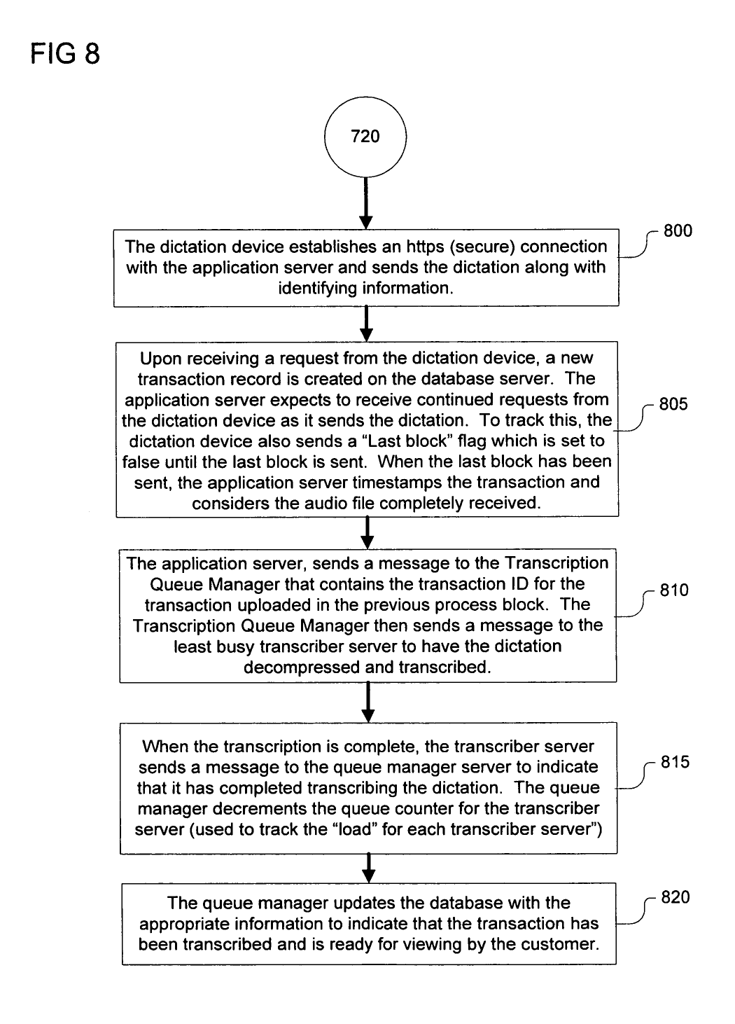

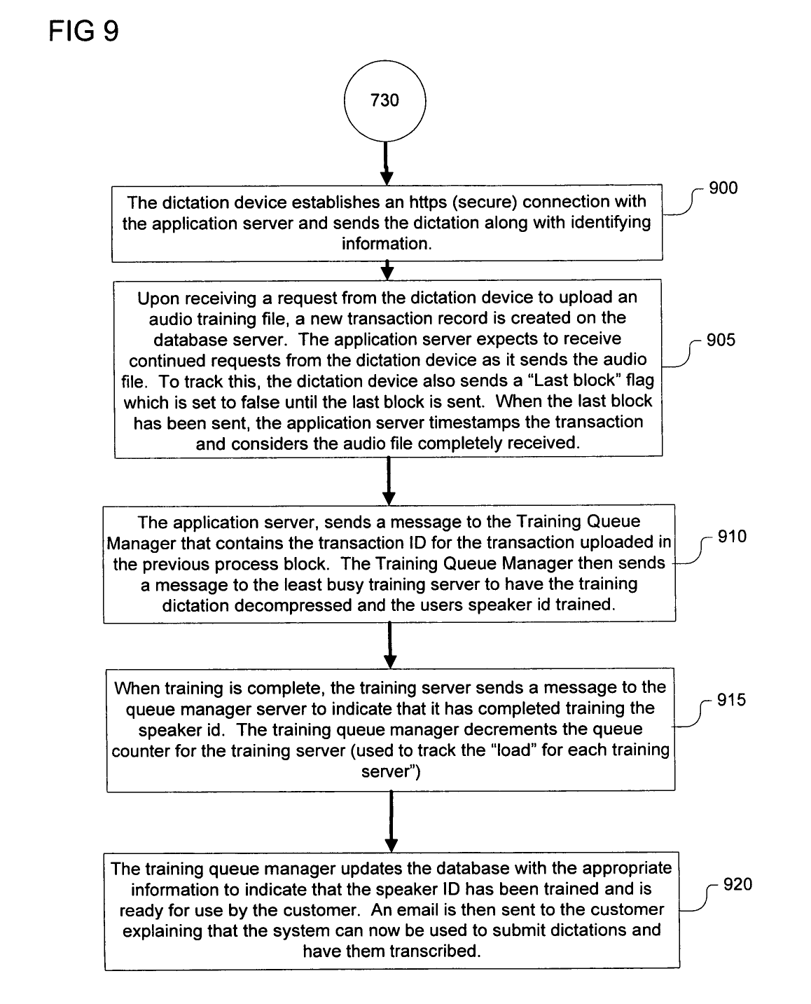

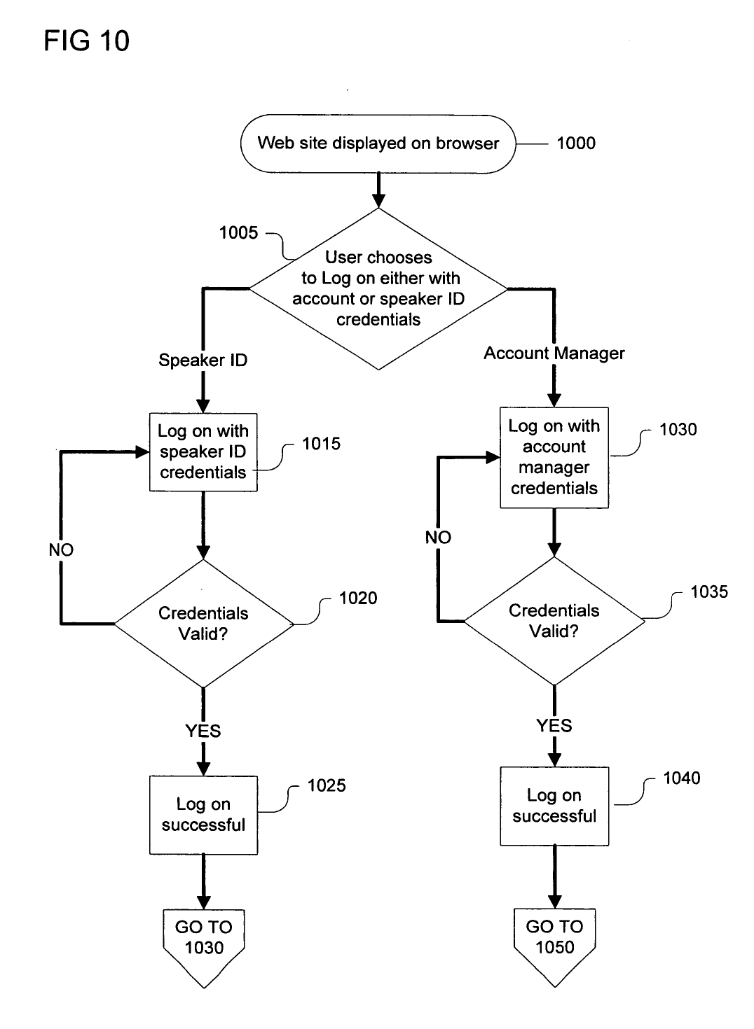

Referring to FIG. 7, the application server logic is shown. The system checks in step 700 to see if a web service message is received from step 702, and if not, system control loops back to step 700 to await input. When a web service message is received, an http request is invoked on the application server in step 705, after which a message label is obtained from the incoming message in step 710. The system checks the message label in step 715 to see if the message label is a request to transcribe, and if so, system control passes to step 720 in FIG. 8. If not, the system checks in step 725 to see if the message label is a request to train, and if so, system control passes to step 730 in FIG. 9. Otherwise, the system checks in step 735 to see if the message label is a request to continual training, and if so, system control passes to step 740 in FIG. 10. Otherwise, the system loops back to step 700 to await input.

Referring to FIG. 8, the server transcription logic is explained. In step 800, the dictation device preferably establishes an https (secure) connection with the application server and sends the dictation along with identifying information. In step 805, upon receiving a request from the dictation device, a new transaction record is created on the database server. The application server expects to receive continued requests from the dictation device as it sends the dictation. To track this, the dictation device preferably also sends a “Last block” flag which is set to false until the last block is sent. When the last block has been sent, the application server timestamps the transaction and considers the audio file completely received. In step 810, the application server preferably sends a message to the Transcription Queue Manager that contains the transaction ID for the transaction uploaded in the previous process block. The Transcription Queue Manager then sends a message to the least busy transcriber server to have the dictation decompressed and transcribed. In step 815, when the transcription is complete, the transcriber server preferably sends a message to the queue manager server to indicate that it has completed transcribing the dictation. The queue manager decrements the queue counter for the transcriber server, which is used to track the load for each transcriber server. Finally, in step 820, the queue manager updates the database with the appropriate information to indicate that the transaction has been transcribed into a processed document and is ready for viewing by the customer. “Processed document” is defined herein as a generic word document in any language, preferably in text format, but optionally in any readable format.

Referring to FIG. 9, the server training logic is explained. In step 900, the dictation device preferably establishes an https (secure) connection with the application server and sends the dictation along with identifying information. In step 905, upon receiving a request from the dictation device to upload an audio training file, a new transaction record is created on the database server. The application server expects to receive continued requests from the dictation device as it sends the audio file. To track this, the dictation device preferably also sends a “Last block” flag which is set to false until the last block is sent. When the last block has been sent, the application server timestamps the transaction and considers the audio file completely received. In step 910, the application server sends a message to the Training Queue Manager that contains the transaction ID for the transaction uploaded in the previous process block. The Training Queue Manager then preferably sends a message to the least busy training server to have the training dictation decompressed and the user's speaker ID trained. In step 915, when training is complete, the training server preferably sends a message to the queue manager server to indicate that it has completed training the speaker ID. The training queue manager preferably decrements the queue counter for the training server, which is used to track the load for each training server.” In step 920, the training queue manager preferably updates the database with the appropriate information to indicate that the speaker ID has been trained and is ready for use by the customer. An email is then sent to the customer explaining that the system can now be used to submit dictations and have them transcribed.

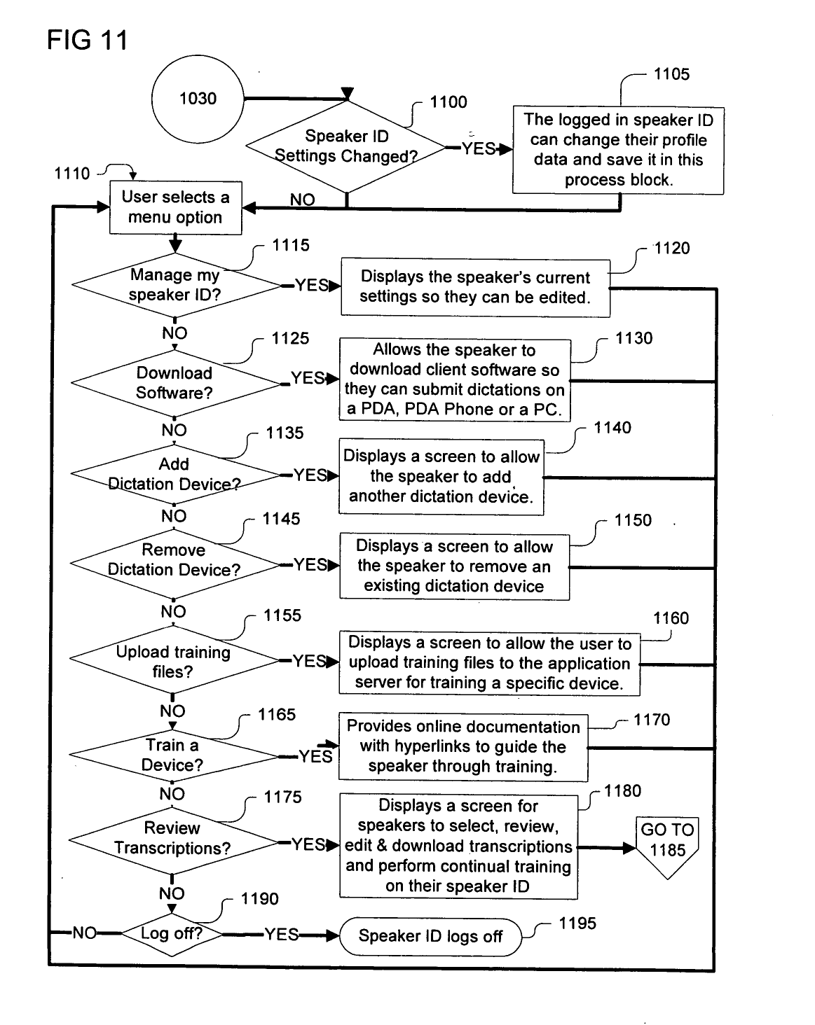

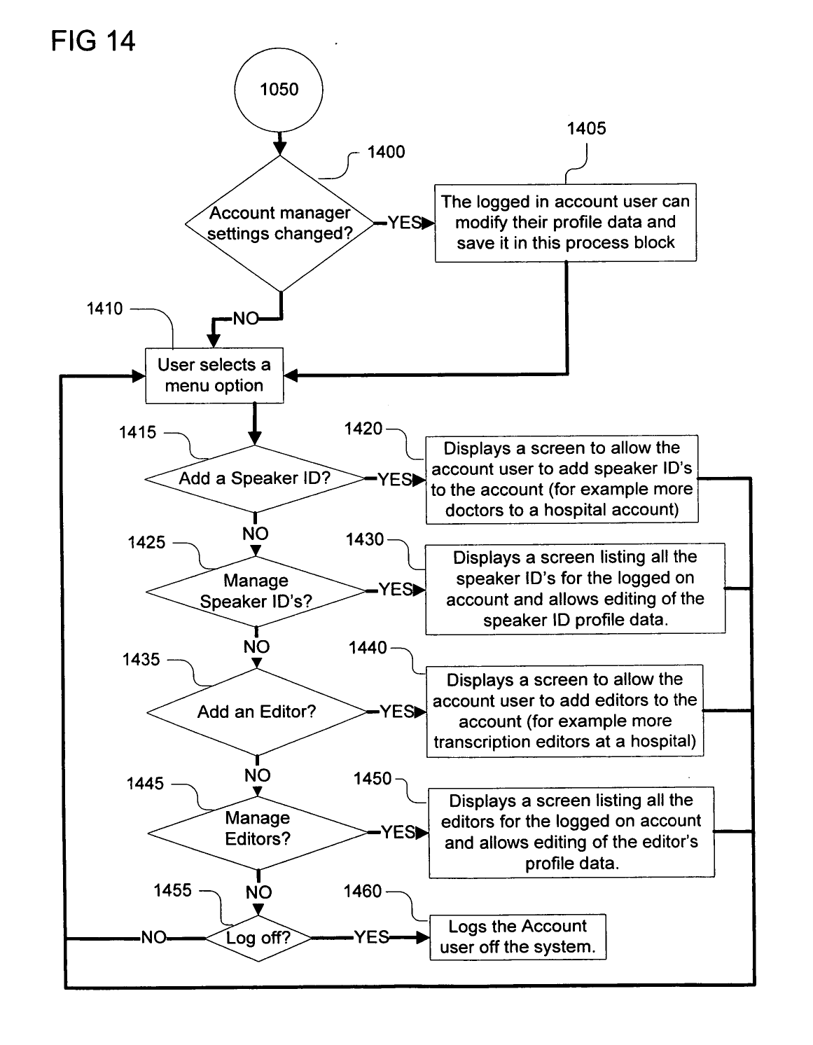

Referring to FIG. 10, the web site logon logic is explained. The user reaches the application website address preferably via the Internet in step 1000. The user can log in with account credentials or with speaker ID credentials in step 1005. If the user chooses to log on with account credentials, the user logs on with account manager credentials in step 1030. The credentials are checked in step 1035 for validity, with invalid credentials causing system control to loop back to step 1030 to await another log on attempt. If the account manager credentials are valid, the log on is successful in step 1040 and system control passes to step 1050 (FIG. 14). If the user chooses to log on speaker ID credentials, the user logs on with speaker ID credentials in step 1015. The credentials are checked by the system in step 1020 for validity. Invalid credentials cause the system to loop back to step 1015 to await another logon with valid credentials. If the credentials are valid in step 1020, the log on is successful in step 1025 and system control passes to step 1030 in FIG. 11.

Referring to FIG. 11, the speaker ID logon menu logic is explained. After the user log on is successful in step 1025 (FIG. 10). the system checks to see if the speaker ID settings are changed in step 1100. If so, the logged in speaker ID can change their profile data and save it in step 1105 after which the user selects a menu option in step 1110. If there is no change in the speaker ID settings, the user selects a menu option in step 1110. The system checks in step 1115 to see if the user selected to manage the user's speaker ID, and if so, the speaker's current settings are displayed in step 1120 so they can be edited. Otherwise, the system checks in step 1125 to see if the user selected to download software, and if so, the user is provided the ability in step 1130 to download client software so the speaker can submit dictations on a PDA, PDA phone, or a PC. Otherwise, the system checks in step 1135 to see if the user selected to add a dictation device, and if so, a screen is displayed in step 1140 so to allow the speaker to add another dictation device. Otherwise, the system checks in step 1145 to see if the user selected to remove a dictation device, and if so, a screen is displayed to allow the speaker to remove an existing dictation device in step 1150.

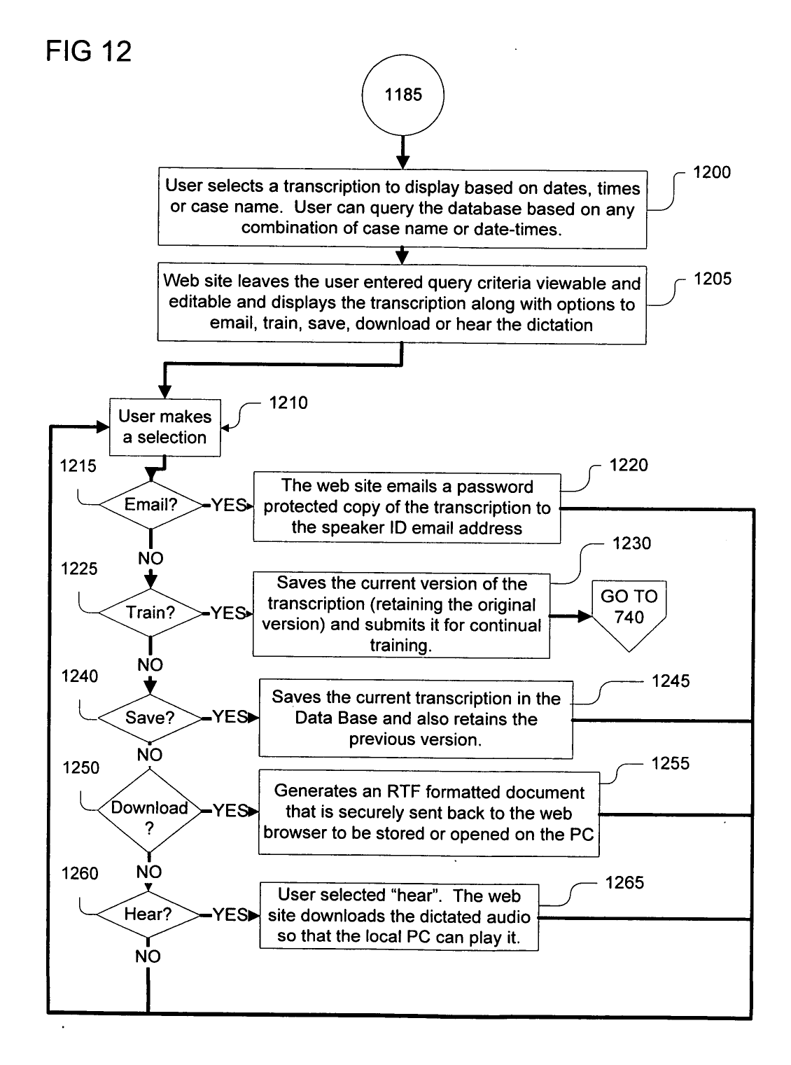

Otherwise, the system checks in step 1155 to see if the user selected to upload training files, and if so, a screen is displayed in step 1160 to allow the user to upload training files to the application server for training a specific device. Otherwise, the system checks in step 1165 to see if the user selected to train a device, and if so, online documentation is provided in step 1170 with hyper links to guide the speaker through the training. Otherwise, the system checks in step 1175 to see if the user selected to review transcriptions, and if so, a screen is displayed in step 1180 to allow the speaker to select, review, edit, and download transcriptions and perform continual training on their speaker ID, after which system control goes to step 1185 in FIG. 12. Otherwise, the system checks in step 1190 to see if the user selected to log off, and if so, the speaker ID logs off in step 1195. Otherwise, the system loops back to step 1110 to await the selection of a menu option by the user.

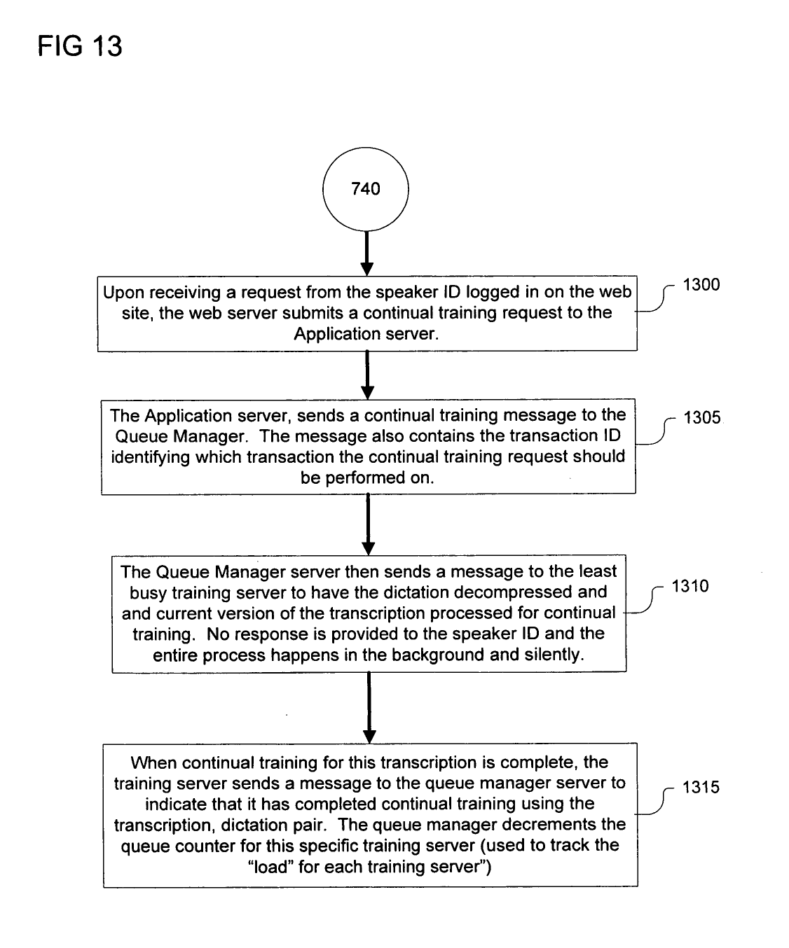

Referring to FIG. 12, the review transcriptions logic is shown. After the user is presented with the screen of choices in step 1180 (FIG. 11), the user selects, in step 1200, a transcription to display based on dates, times, or case name. The user preferably can query the database based on any combination of case name or dates & times. In step 1205, the website preferably leaves the user entered query criteria viewable and editable, and preferably displays the transcription along with options to Email, Train, Save, Download, or Hear the dictation. The user makes a selection in step 1210. In step 1215, the system checks to see if Email is selected, and if so, the web site preferably emails a password protected copy of the transcription to the speaker ID email address, after which system control loops to step 1210. If not, the system checks in step 1225 to see if Train is selected, and if so, the current version of the transcription is saved, while retaining the original version, and submits it for continual training, after which system control goes to step 740 (FIG. 13). If not, the system checks in step 1240 to see if the user selects Save, and if so, the current transcription is saved in the database along with the previous version, after which system control loops back to step 1210. Otherwise, the system checks to see if Download is selected, and if so, an RTF formatted document is preferably generated in step 1255 that is preferably securely sent back to the web browser to be stored or opened on a PC, after which system control loops back to step 1210. If Download is not selected at this point in the process, the system checks in step 1260 to see if Hear is selected, and if so, the web site downloads in step 1265 the dictated audio so that the local PC can play the audio, and if not, system control loops back to step 1210.

Referring to FIG. 13, the continual training logic is shown. In step 1300, upon receiving a request from the speaker ID logged in on the web site, the web server submits a continual training request to the Application server. The Application server, in step 1305, sends a continual training message to the Queue Manager. The message also preferably contains the transaction ID identifying which transaction the continual training request should be performed on. The Queue Manager server then sends, in step 1310, a message to the least busy training server to have the dictation decompressed and the current version of the transcription processed for continual training. No response is provided to the speaker ID and the entire process happens in the background and silently. When continual training for this transcription is complete, in step 1315 the training server sends a message to the queue manager server to indicate that it has completed continual training using the transcription-dictation pair. The queue manager decrements the queue counter for this specific training server. This is used to track the “load” for each training server.”

Referring to FIG. 14, the account manager menu logic is explained. If the user accesses the web site and logs on with account manager credentials (FIG. 10), the system checks in step 1400 to see if the account manager settings are changed, and if so, the logged in account user can modify their profile data and save it. The user then selects a menu option in step 1410. If the account manager settings are not changed, the user goes directly to step 1410 to select a menu option. The system checks in step 1415 to see if the menu option Add a Speaker ID is chosen, and if so, a screen is displayed in step 1420 which preferably allows the user to add speaker ID's to the account, after which system control loops back to step 1410. If not, the system checks in step 1425 to see if the menu option Manage Speaker ID's is chosen, and if so, a screen is displayed in step 1430 which preferably lists all the speaker ID's for the logon on account and allows editing of the speaker ID profile data, after which system control loops back to step 1410. If not, the system checks in step 1435 to see if the menu option Add an Editor is chosen, and if so, a screen is displayed in step 1440 which preferably allows the account user to add editors to the account, after which system control loops back to step 1410. If not, the system checks in step 1445 to see if the menu option Manage Editors is chosen, and if so, a screen is displayed in step 1450 which preferably lists all the editors for the logged on account and allows editing of the editor's profile data, after which system control loops back to step 1410. If not, the system checks in step 1455 to see if the menu option Log Off is chosen, and if so, the account user is logged off the system, and if not, system control loops back to step 1410.

Referring to FIG. 15, the application service server network topology is shown. The public network portion includes application server 1500, a web server 1510 which hosts the web site, and email server 1525. The private network portion preferably includes a domain controller 1505, a database server 1515, a transcription queue manager 1520, and a training queue manager 1545. Transcription queue manager 1520 further preferably includes a plurality of transcribers 1530, 1535, and 1540. Training queue manager 1545 further preferably includes a plurality of trainers 1550, 1555, and 1560. Additional transcribers and trainers are optionally added as required.

While the present invention has been described with reference to a particular preferred embodiment and the accompanying drawings, it will be understood by those skilled in the art that the invention is not limited to the preferred embodiment and that various modifications and the like could be made thereto without departing from the scope of the invention as defined in the following claims.

What is claimed is:

1. A system for dictation and transcription, comprising:
means for receiving an audio file from a user via a first Internet connection;
batch transcription means for batch computer transcription of the audio file into a processed document; and
means for making the processed document available to the user via a second Internet connection and/or e-mail.

2. A system according to claim 1, further comprising device means for sending the audio file from the user to the system via the first Internet connection.

3. A system according to claim 2, further comprising training means, co-located with the transcription means, for building a voice profile based on user input into the device means, wherein the voice profile is used by the transcription means to convert the audio file into the processed document.

4. A system according to claim 2, wherein the device means includes means for recording the audio file from a voice of the user.

5. A system according to claim 4, wherein the device means is one of a personal digital assistant, tablet, personal computer, cell phone, cell phone personal digital assistant, or laptop.

6. A system according to claim 4, further comprising means for verifying credentials of the user before permitting the system to receive the audio file from the user via the first Internet connection.

7. A method for dictation and transcription, comprising the steps of:
receiving an audio file from a user via a first Internet connection;
transcribing, using a computer in batch mode, the audio file into a processed document; and
making the processed document available to the user via a second Internet connection and/or e-mail.

8. A method according to claim 7, further comprising the step of sending the audio file from the user to the computer using a device via the first Internet connection.

9. A method according to claim 8, further comprising the step of building a voice profile based on user input into the device, wherein the voice profile is used in the step of transcribing to convert the audio file into the processed document.

10. A method according to claim 9, further comprising the step of recording an audio file into the device from a voice of the user.

11. A method according to claim 10, wherein the device is one of a personal digital assistant, tablet, personal computer, cell phone, cell phone personal digital assistant, or laptop.

12. A method according to claim 10, further comprising the step of verifying credentials of the user before permitting the computer to receive the audio file from the user via the first Internet connection.

13. A program storage device readable by a machine, tangibly embodying a program of instructions executable by a machine to perform method steps for dictating and transcribing an audio file, the method steps comprising:
recording an audio file produced by a user on a dictation device;
storing the audio file on the communications device; and
sending the audio file via the Internet to a system for computerized batch transcription into a processed document.

14. A program storage device according to claim 10, wherein the dictation device is one of a personal digital assistant, tablet, personal computer, cell phone, cell phone personal digital assistant, or laptop.
